(19) United States
(12) Patent Application Publication
(10) Pub. No.: US 2011/0314376 A1
(43) Pub. Date: Dec. 22, 2011

(54) METHOD AND SYSTEM THAT DISPLAYS A TOOLTIP

(76) Inventors: Michael Dearman, Lakewood, NY (US); Albert Cecchini, Jamestown, NY (US)

(21) Appl. No.: 13/163,267

(22) Filed: Jun. 17, 2011

Related U.S. Application Data
(60) Provisional application No. 61/398,240, filed on Jun. 18, 2010.

(51) Int. Cl. G06F 3/048

(52) U.S. Cl. 715/711

(57) ABSTRACT

When zooming in on (or magnifying) a field of a user interface (UI) it would be advantageous to be able to dynamically view a label of the field and input into an input element of the field without having to scroll a magnified or zoomed UI. By providing a tooltip adjacent to, abutting, or overlapping the input element, it is possible to view the tooltip and enter into the input element without scrolling the UI. The tooltip is activated upon the occurrence of a monitored, and the tooltip when activated displays information pertinent to other user interface elements at the location of a cursor or its equivalent. Furthermore, the size and the location of the tooltip may be controlled with respect to the other user interface elements so that the information pertinent to the other user interface elements are within view of a user at various degrees of screen magnification.

### CROSS REFERENCE TO RELATED APPLICATION

The present application claims priority to U.S. Provisional Patent Application No. 61/398,240, filed Jun. 18, 2010. The contents of that application are hereby incorporated by reference.

### TECHNICAL FIELD

The present invention relates to tooltips, hover boxes, popup windows, and any user interface (UI) element that provides information on another UI element that is activated by a particular user or user interface event. For the purposes of this disclosure, UI elements that are often considered variants of a tooltip, such as hover boxes, status bars, balloon help, ScreenTip, mouseover, and the like are to all be encompassed by the definition of tooltip. In particular, the invention relates to methods and systems for displaying such tooltips.

### BACKGROUND

In general, tooltips are activated or deactivated by a user or user interface event, such as a mouse click, key press, keyboard shortcut, mouse cursor hovering, or a message from another program or thread. Event-driven programming is usually employed where a desired functionality is interrelated with such events. For example, the activation and deactivation of a tooltip occurs as a result of a user key-press or mouse event. Tooltips increase the efficiency of working with forms, especially large forms having fields which contain data, by providing context sensitive help lending understanding to the meaning of the data.

The present invention also relates to screen magnifier programs. Screen magnifier programs or screen magnifier program elements in computer applications are often used by the visually impaired to make seeing information on the screen easier. In addition, screen magnification assists any type of user that desires to enlarge or shrink displayed textual or graphic information. Such zoom functionality is especially useful in a large form document containing user editable and non-editable displayed data in fields within a document. The ability to zoom in and out of a document element increases the ease of use when working with large forms with many fields, sections, and sub-sections. Unfortunately, a drawback to screen magnification on a fielded form is that the field label is out of view when the cursor is within the field and the field is within view. This drawback is not only present with fields on forms but also with any other objects on the screen including menus, drop-downs, buttons, and the like.

Though both technologies are useful for the purposes described above, the tooltip technology has never been applied to keep a field label (or other important information) within the field of vision of the user. For example, when a user zooms in on a field (i.e. magnifies a field) the label or the input element of the field is often out of view of the user. To remedy the issue, the user currently needs to use a scrollbar to read the label and then scroll again to enter text into the input element. In a large form having many fields, using a scrollbar to read field labels and then being required to scroll to enter information into the input element becomes cumbersome, especially for the visually impaired. Henceforth, described herein are novel methods embodied through a novel event handler that effectively utilizes tooltip technologies to resolve common UI issues such as the one given in the preceding example.

### SUMMARY

As suggested in the example above, it would be advantageous to be able to view both the field and the associated label without having to scroll a magnified window. The present invention addresses this need in the art. In an exemplary embodiment, the methods are enabled by a software and/or hardware based event handler. The event handler monitors the location of a real cursor, cursor alias, and/or mouse cursor (i.e. the cursor) and controls tooltip size and location of a tooltip with respect to the cursor so that both a field label and a form input element are within a field of vision of a user at various screen magnifications. The novel methods can be initiated by mouse click, key press, menu selection, or other common event activation methods known to the art. The size of the tooltip is predicated on the monitoring of the amount of content to be displayed and the current screen magnification. The monitoring of field elements and the cursor provides information necessary for the event handler to control the tooltip's location with respect to the field. In one embodiment, the novel methods, enabled by the event handler, position the tooltip adjacent to, abutting, or overlapping the input element of a field in a manner where both the tooltip and the input element are viewable in the magnified window without scrolling the window. The novel methods enabled by the event handler, not only applies to fields on forms but also with any other objects on a screen including menus, drop-downs, buttons, and the like.

The invention also includes software elements including instructions and other software processing means that when executed by a processor of a computer system cause the processor to implement the methods of the invention. The invention further includes computer readable storage media that stores instructions that when executed by a processor cause the processor to implement the methods of the invention. Such systems and computer readable storage media are also within the scope of the invention described herein.

### BRIEF DESCRIPTION OF THE DRAWINGS

FIG. 1A illustrates an example screen representation of a user interface (UI) for implementing embodiments of the methods of the invention.

FIG. 1B illustrates an exemplary embodiment in which an event handler monitors user and/or automated interactions and has activated a tooltip based on the location of a real cursor to the display while keeping in view textual content associated with the field in which the cursor was residing when the event handler activated and positioned the tooltip.

FIG. 2 illustrates another example screen representation of a UI for implementing embodiments of the methods of the invention.

FIGS. 3-5 illustrate further example screen representations of a UI for implementing embodiments of the methods of the invention.

FIG. 6 illustrates an exemplary embodiment of the method of the invention as implemented by an event handler.

FIG. 7 illustrates a block diagram of an embodiment of a computer system for implementing the methods of the invention.

### DETAILED DESCRIPTION OF ILLUSTRATIVE EMBODIMENTS

Example methods for overcoming the above-described disadvantages associated with screen magnification are described below.

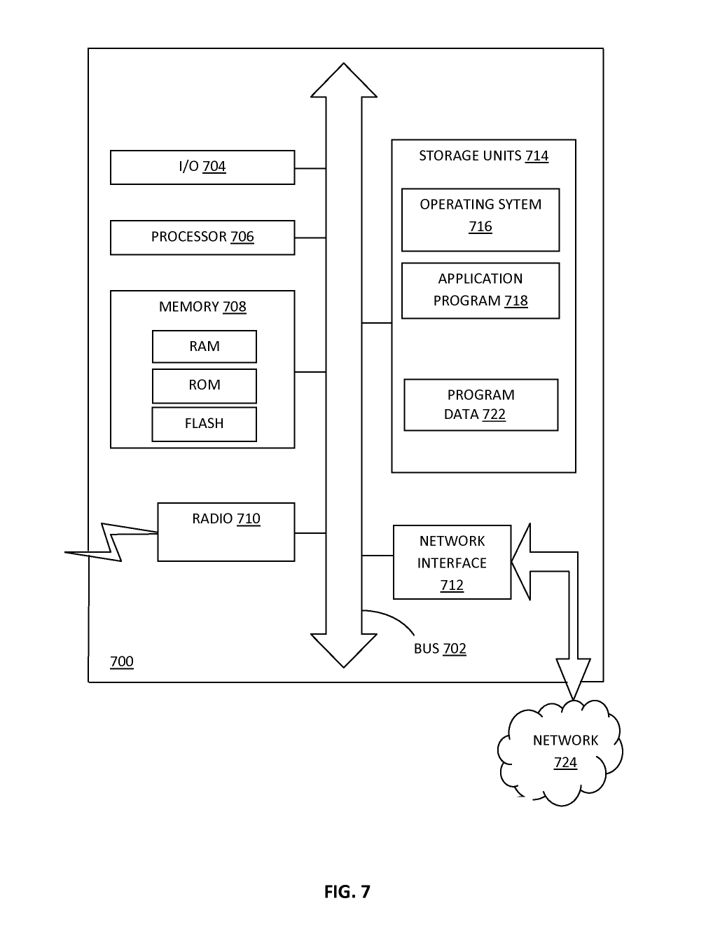

FIG. 7 illustrates a block diagram of an example computer system for implementing the methods of the invention. As illustrated, FIG. 7 includes a computer 700 running software, such as a computer application program 718 and an operating system 716. The computer 700 includes a processor 706 in communication with a computer readable storage medium, where the computer readable storage medium is any medium that stores information for retrieval later by the processor 706. In an exemplary embodiment, the computer readable storage medium includes memory 708 and data storage units 714. Memory 708 is possibly a fast-access memory and is used to run program instructions executable by the processor 706. Memory 708 also may be random access memory (RAM), read only memory (ROM), and/or flash memory. Data storage units 714 are possibly physical devices and are used to store any data and instructions that may be accessed by the processor 706, such as program data 722 and instructions for the computer application program 718 and the operating system 716. Data storage units 714 and their associated computer readable storage media provide storage of computer readable instructions, data structures, program modules, and other data for the computer 700. Data storage units 714 are possibly an optical medium, a magnetic medium such as a floppy disk, a compact disc (CD), a digital video disk (DVD), and/or a solid-state medium such as RAM, ROM, and flash memory.

The computer application program 718 is any computer software that assists a user to perform a task or multiple related tasks. For example, the methods described herein are preferably implemented by a computer application program including means in the form of computer instructions that when executed by a processor cause the processor to implement each of the steps of the methods described herein. The methods described herein also may be implemented by processing instructions stored on a computer readable storage medium where the instructions, when executed by a processor, cause the processor to implement each of the steps of the methods described herein. The computer readable storage medium may be any kind of volatile or non-volatile medium, such as RAM, ROM, or flash memory, capable of storing the instructions until the instructions may be executed by the processor.

The operating system 716 is a standard computer operating system that includes fundamental user interface (UI) components such as a window. A window (i.e. application window) is an area on a display device that displays information for a specific program and other user interface (UI) elements. For example, an application window often includes a label bar, a toolbar, and a display area that shows the content of an application. Operating systems includes versions of: MICROSOFT WINDOWS, MAC OS, X WINDOW SYSTEM, and UBUNTU. Window operating systems also include mobile device operating systems such as SYMBIAN OS, ANDROID, iOS, RIM BLACKBERRY OS, and WINDOWS MOBILE.

The computer 700 also includes a radio 710 or another type of communications device for wirelessly transmitting and receiving data.

In addition, the computer 700 may operate in a networked environment using logical connections to other computers and communication devices via network 724. The computer 700, other computers, and communication devices are possibly a personal computer, a server, a router, a network PC, a peer device, a printer, or other common network nodes. When used in a LAN or WLAN networking environment, the computer 700 is connected to the other computers and communication devices via the LAN or WLAN through a network interface 712.

The computer 700 also includes input/output devices 704 for providing input to the processor 706, the memory 708, the radio 710, the storage units 714, the network interface 712, and other electrical components of the computer 700 and the output of the electrical components of the computer 700 to other electrical components of the computer 700, other electrical components of other computers, or a user of the computer 700 or other computers. For example, a display device provides output of the electrical components to a user.

A bus 702 and other circuitry assist in connecting the input/output devices (I/O) 704 to various electrical components of the computer 700. The above-mentioned applications programs and the electrical components of the computer are made of computer hardware, software, firmware, or any combination thereof. The communications among such components occur in the form of signals including electronic signals, electromagnetic signals, optical signals, or any combination thereof.

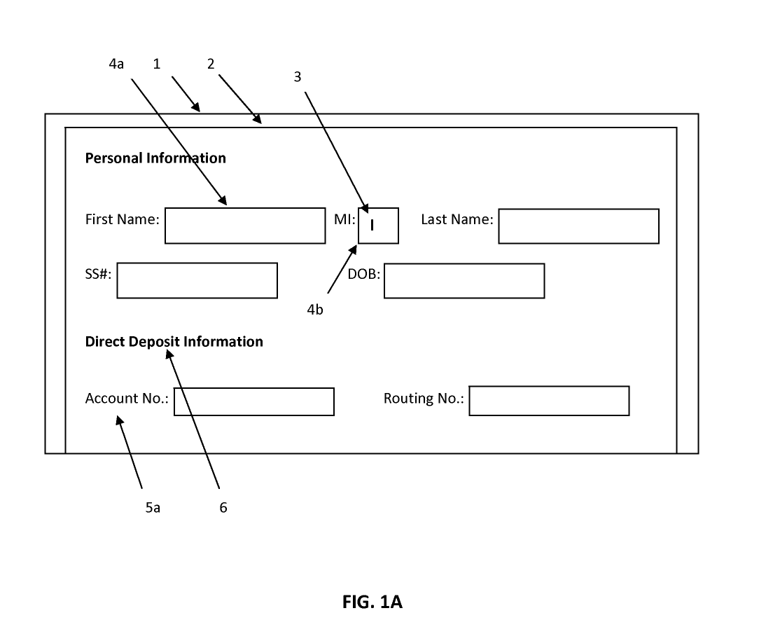

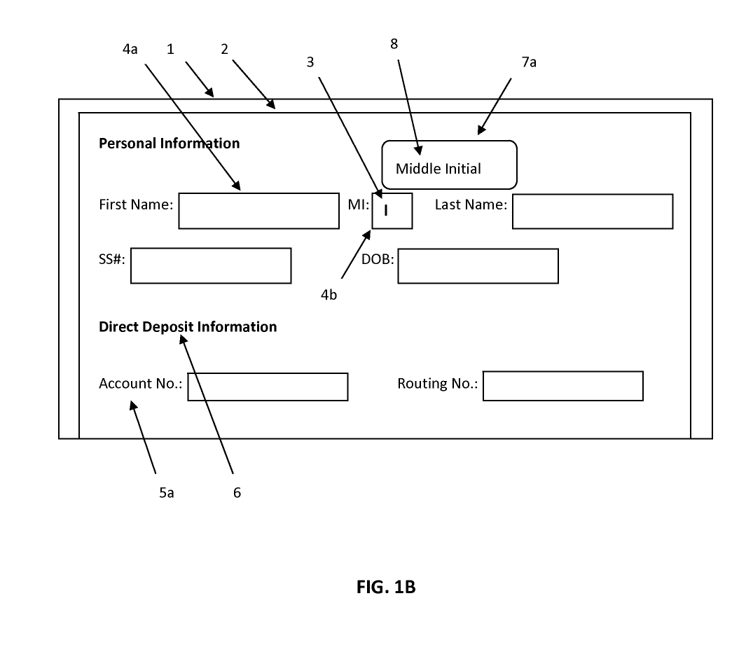

FIG. 1A illustrates an example screen representation of a user interface (UI) for implementing embodiments of the methods of the invention, where the computer system of FIG. 7 or another computer system hosts a computer application program or operating system that renders the example screen represented in FIG. 1A. FIG. 1A includes a computer application window 1, a form 2, a cursor 3, field input elements (e.g. field input elements 4a & 4b), field labels (e.g. “Account No.” 5a), and form section headers (e.g. “Direct Deposit Information” 6). The computer application window 1, which is displayed on a computer monitor or a communications device display, displays the form 2 that displays the user input elements for fields, the field labels, and the form section headers. The user input elements may include text, graphics, audio, form elements, such as headers, labels, lists, and user input elements, such as text fields, checkboxes, radio-buttons, data grids, links and buttons, and any combination thereof.

FIG. 1B illustrates an exemplary embodiment wherein a novel event handler monitors user and/or automated interactions and has activated a tooltip 7a based on the location of a real cursor 3 to display and keep in view textual content 8 associated with the field 4b in which the cursor 3 was residing when the event handler activated and positioned the tooltip 7a. Alternatively, the real cursor 3 can be substituted with a cursor alias, color bar, mouse cursor, mouse click, voice command, or other positioning means.

In an embodiment of the methods of the invention, the tooltip 7a is activated or deactivated by a user or user interface event, which is either one or more mouse clicks (button presses), mouse movements, mouseovers (i.e. hovering the mouse pointer over a particular field), key presses on a key board (e.g. a key stroke, a keyboard shortcut, switching the cursor to another field via a tab key press, and the like), touch screen tactile interacts, voice commands, cursor alias movement, color changes, menu selections, other user actions, messages from other user programs or threads, and the like, or any combination thereof. The activation of the tooltip 7a includes the appearance and positioning of the tooltip 7a; however, preferably, activation can also include audio output of the tooltip's content or other multimedia. Deactivation of the tooltip 7a includes the tooltip 7a disappearing from the UI, which may occur after a particular period of time or upon a particular user request such as a user key press recognized by the event handler. The event handler may also be activated by an event such as the afore-mentioned user interface events.

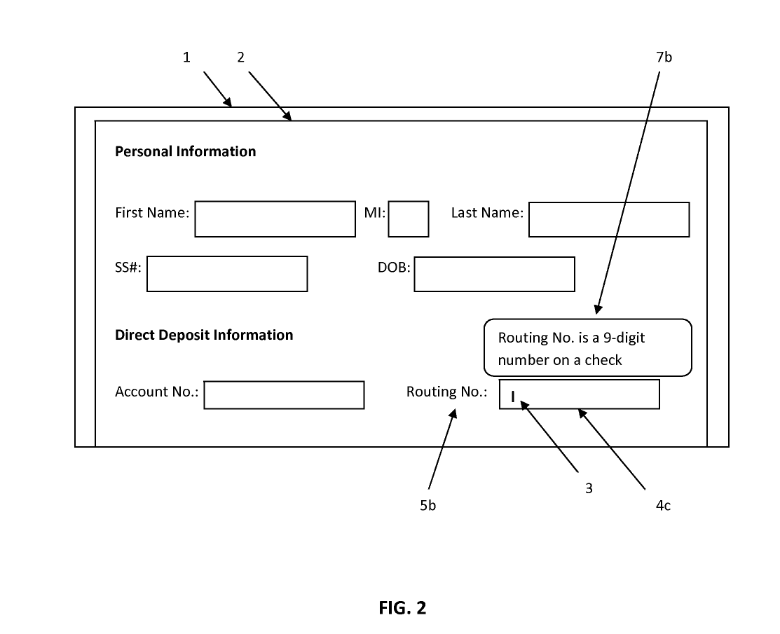

FIG. 2 illustrates another example screen representation of a UI for implementing embodiments of the methods of the invention, where the computer system of FIG. 7 or another computer system hosts a computer application or operating system that renders the example screen represented in FIG. 2. FIG. 2 includes elements from FIG. 1, and in FIG. 2, the cursor 3 has moved from the “MI” field to the “Routing Number” field 4c. Because the real cursor 3 in FIG. 2 is located in the “Routing Number” field, labeled “Routing No.”, the novel event handler has tracked the cursor movement and has closed the tooltip 7a corresponding to the “MI” field and has opened and repositioned the tooltip 7b corresponding to the field 3 with the “Routing No.” label 5b.

Preferably, the cursor moves to and from each field or UI element of the application window 1 by a tab key stroke (e.g. the cursor moving from one field input to another field input by way of tab keystroke). In such embodiments, it is preferred to include an event handler feature whereupon the cursor entering a field or at another time after the cursor enters the field, the UI focuses or zooms in on the input element of the field and displays the tooltip related to the field within close proximity to the input element, abutting the input element, or overlapping (i.e. hovering over) the input element. For example, such embodiments are preferred when the methods are implemented with screen magnification software for the visually impaired.

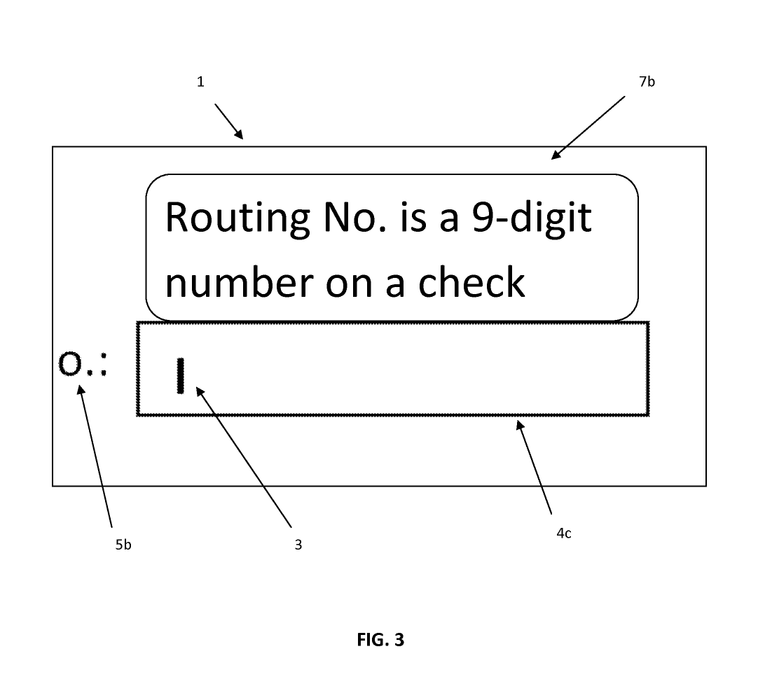

FIGS. 3-5 illustrate example screen representations of a UI for implementing embodiments of the methods of the invention, where the computer system of FIG. 7 or another computer system hosts a computer application or operating system that renders the example screens represented in FIGS. 3-5. FIGS. 3-5 include elements from FIGS. 1A, 1B and 2, and illustrate the form shown in FIGS. 1A, 1B, and 2; however, screen magnification has been implemented to a degree where elements of the “Routing No.” field 5b, 4c, & 7b take up the majority of space of the application window 1. In FIGS. 3-5, magnification is to the point where only a portion of the field label 5b is included, but the window 1 does display the tooltip 7b related to the field 4c, which provides pertinent information as to which field has been entered.

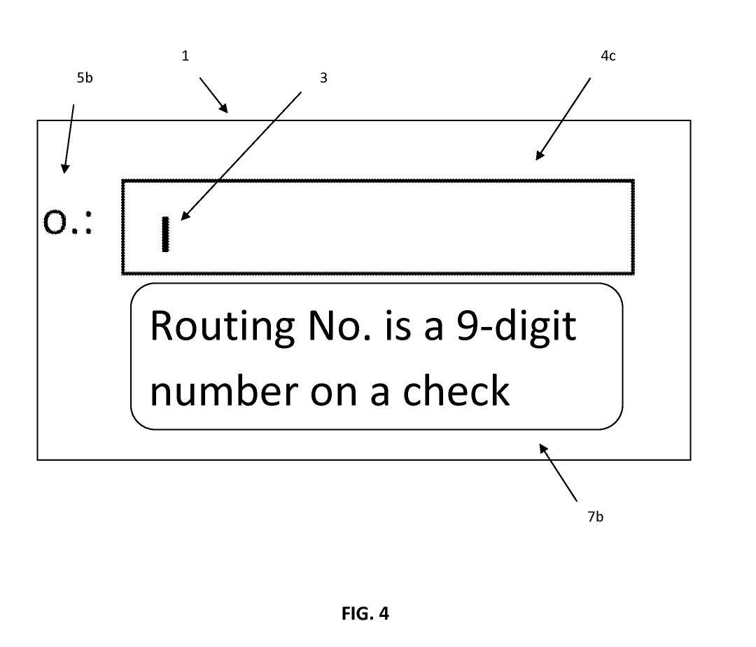

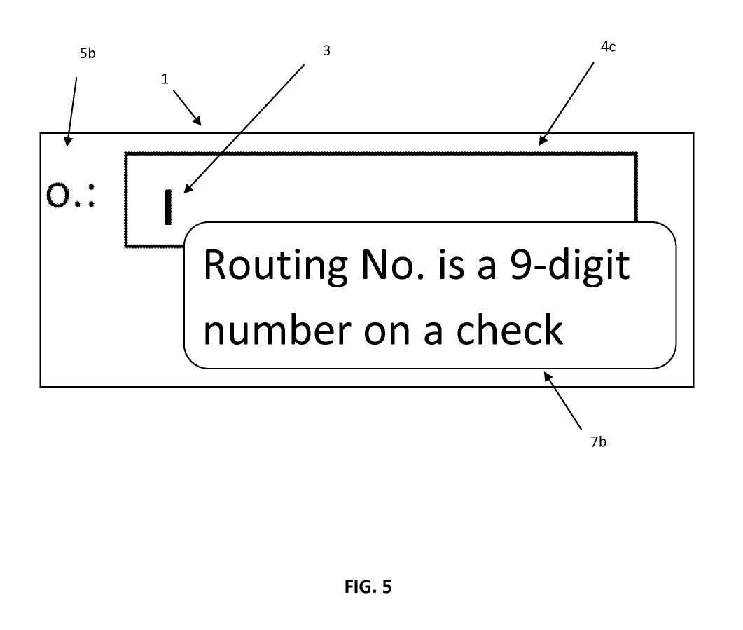

When screen magnification is applied, especially to the point where the magnified window can only contain a single field of a form or document, UI elements (including a tooltip) of a field are arranged by the novel event handler so that an input element is visible and information pertaining to the field is visible in the window without needing to scroll the window. With reference to FIG. 1B, the novel event handler causes the application window to display a tooltip 7a within close proximity to the middle initial (MI) field input element 4b of the particular field. As illustrated, the tooltip 7a is above the field input element 4b; however, alternatively, the methods may position the tooltip 7a to the side or below (e.g. See FIG. 4) a field input element. Alternatively, a tooltip may be positioned to abut (e.g. See FIG. 3) or overlap (e.g. See FIG. 5) a field input element.

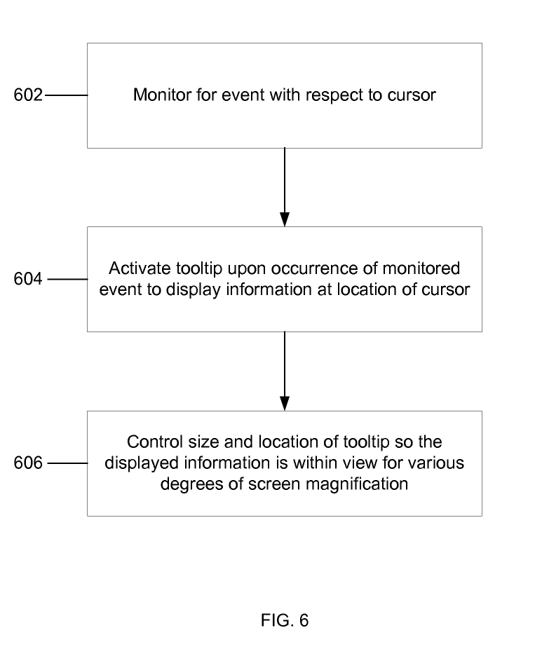

As illustrated in FIG. 6, the method is implemented by an event handler that may be, for example, implemented as an application program 718 and stored in storage units 714 of computer 700. In an exemplary embodiment, the event handler is implemented as a set of computer instructions that, when processed, cause the processor 706 to implement the steps of monitoring (602) for at least one event occurring with respect to a cursor of a user interface, activating a tooltip (604) upon the monitored event occurring, where the tooltip may enter at least one of the pertinent user interface elements and, when activated, displays information pertinent to other user interface elements at a location of the cursor, and controlling size and location of the tooltip with respect to the other user interface elements (606) so that the information pertinent to the other user interface elements are within view of a user at various degrees of screen magnification. The tooltip is preferably positioned within close proximity to, abutting, or overlapping at least one of the other user interface elements. The event handler preferably implements the method within an active application window and the information pertinent to the other user interface elements is within view without having to scroll the application window. The monitored event may be selected from a group of events including, for example, key presses on a keyboard, mouse movements, mouse button presses, mouseovers, touch screen tactile interacts, voice commands, cursor alias movement, color changes, menu selections, and any combination thereof. The cursor may also be selected from a group including a real cursor, a cursor alias, a mouse cursor, and any combination thereof.

In exemplary embodiments of the invention, the pertinent user interface elements are selected from a group including text, graphics, audio, form elements, such as headers, labels, lists, and user input elements, such as a text fields, checkboxes, radio-buttons, data grids, links and buttons, and any combination thereof. The information displayed in the tooltip also may be selected from a group including graphical and textual elements, such as buttons, multimedia, lists, grids, text narratives, text labels, and blurbs, and any combination thereof, such as labels including text and graphics. In addition, a tooltip controller may be implemented that facilitates controlling attributes of the tooltip. Such attributes include, for example, overall size of the tooltip and elements of the tooltip; specific elements of the tooltip to hide; specific elements of the tooltip to display; volume of audio output and muting audio output; colors of the tooltip; manual positioning of the tooltip; automated positioning of the tooltip; default positioning of the tooltip; speed of the tooltip positioning and appearing; speed of the tooltip hiding; flashing of the tooltip and elements of the tooltip; content of the tooltip and elements of the tooltip; and administrative rights of the tooltip.

In exemplary embodiments of the invention, activation and deactivation of the tooltip is automatic so that the tooltip appears and disappears based on an occurrence of a particular user event from another source selected from a group including, for example, operating system messages, application messages, hardware messages, network communications, embedded algorithm communications, and timer communications. Deactivation of the tooltip may result from a particular user event so that the tooltip appears indefinitely until an occurrence of the particular user event.

The event handler also may be implemented as a set of computer instructions that, when processed, cause the processor 706 to implement the steps of monitoring for an event at first and second user interface elements, where the first user interface element is an indicator of position and where the second user interface element is at the location of the indicator of position, activating a tooltip upon occurrence of the monitored event, where the tooltip when activated displays information associated with the second user interface element, and controlling size and location of the tooltip with respect to the first and second user interface elements so at least the first and second user interface elements and the tooltip are within view of a user at various degrees of screen magnification. In an exemplary embodiment, the active application window is the first user interface element, which is a cursor, and the event includes the cursor entering the second user interface element. The first user interface element is preferably selected from a group of position indicators including a real cursor, a cursor alias, a mouse cursor, and any combination thereof, while the second user interface element is preferably selected from a group including text, graphics, audio, form elements, such as headers, labels, lists, and user input elements, such as a text fields, checkboxes, radio-buttons, data grids, links and buttons, and any combination thereof.

The methods further include determining the location of the tooltip based on the location of a relevant UI element in the application window and the size of the application window relative to the magnification of the content within the window. For example, in FIG. 3 an input element of a field 4c is closer to the bottom of an application window 1 due to magnification of content inside the application window 1, the size of the window 1, and the location of the input element 4c. Upon or following the movement of the real cursor into a field, a tooltip 7b is displayed above the input element 4c, because the input element 4c is closer to the bottom of the window 1 and there is space above the input element 4c to display the tooltip 7b. Therefore, the input element 4c and pertinent information to the element 4c via the tooltip 7b is not cut-off by borders of the window 1. Similarly, in FIG. 4, the input element 4c and the tooltip 7b are not cut-off by borders of the window 1; in this case, the tooltip 7b is below the input element 4c because the input element 4c is closer to the top of the window 1. Preferably, where the window 1 is too small to contain the input element 4c and the tooltip 7b, the tooltip 7b overlaps the input element 4c (e.g. See FIG. 5), a field label, or another type of UI element so that all pertinent information is within the window 1.

Embodiments of the methods also include providing information for other application elements within a field of vision such as buttons, menu items, list boxes, drop-down lists, check boxes, radio buttons, data-grids, and the like.

Preferably, the active application window is a web browser window; event-detection and event-handling of the user interface event is implemented by a scripting language, such as JavaScript; and a cross-platform and language-independent convention for representing and interacting with objects in a document, such as DOM, is utilized and implemented by the scripting language or an alternative programming language, such as C++, to provide various features and functions of the methods of the invention. JavaScript-based event handling and detection or another type of event-driven control use DOM or another cross-platform and language-independent convention for representing and interacting with objects in HTML, XHTML, and XML documents.

In several embodiments of the methods, there are particular inputs for turning on and off the various elements of the methods, such as a particular input for turning on and off the ability of the novel event handler to activate and deactivate a tooltip. The particular inputs for turning on and off the elements of the methods are possibly a key press, a keyboard shortcut, a selection of an item from a user preference window or a menu, or the like. In addition to turning on and off elements of the methods, parameters of such elements may be adjusted in a similar manner. For example, selecting parameters related to a tooltip may be set from a key press, a keyboard shortcut, mouse click, mouse hovering, a selection of an item from a user preference window or a menu, or the like. Preferably, the selectable item is from a tooltip controller UI, such as a tooltip tab of a user preferences window. The tooltip controller UI allows for controlling several attributes of tooltip functionality, including: an amount of time a tooltip is displayed; overall size of the tooltip; elements of the tooltip, including specific elements of the tooltip to hide or display; font size of the tooltip; magnification of the tooltip; whether an ability to activate a tooltip is activated; a user event that initiates a tooltip; a user event that hides a tooltip; color scheme of the tooltip; volume of audio output and muting audio output; manual positioning of the tooltip; automated positioning of the tooltip; default positioning of the tooltip; speed of the tooltip positioning and appearing; speed of the tooltip hiding; flashing of the tooltip and elements of the tooltip; content of the tooltip; administrative rights of the tooltip, or any combination thereof. Typically, the default text size of a tooltip is approximately the same size as text of a label of the field, whether or not screen magnification is applied to a window displaying the elements of the field. In embodiments having the ability to control color scheme, it is preferred to have several color schemes that are supported for visual accessibility including high contrast color schemes, schemes for color blindness, black on white schemes, white on black schemes, blue on white schemes, and black on yellow schemes.

In an exemplary embodiment, activation and deactivation of the tooltip is automatic so that the tooltip appears and disappears based on an occurrence of a particular user event from another source selected from a group including, for example, operating system messages, application messages, hardware messages, network communications, embedded algorithm communications, and timer communications. Deactivation of the tooltip may also result from a particular user event so that the tooltip appears indefinitely until an occurrence of the particular user event.

Though various embodiments of the present invention have been described above, it should be understood that embodiments have been presented by way of example, and not limitation. A person of ordinary skill in the art will recognize that there are various changes that can be made to the present invention without departing from the spirit and scope of the present invention. Therefore, the invention should not be limited by any of the above-described example embodiments, but should be defined only in accordance with the following claims and equivalents of the claimed invention.

What is claimed:

1. A method implemented by an event handler, comprising:
monitoring for at least one event occurring with respect to a cursor of a user interface;
activating a tooltip upon the monitored event occurring, where the tooltip when activated displays information pertinent to other user interface elements at a location of the cursor; and
controlling size and a location of the tooltip with respect to the other user interface elements so that the information pertinent to the other user interface elements are within view of a user at various degrees of screen magnification.

2. The method of claim 1, where the method occurs within an active application window and the information pertinent to the other user interface elements is within view without having to scroll the application window.

3. The method of claim 2, where the tooltip enters at least one of the pertinent user interface elements.

4. The method of claim 1, where the monitored event is selected from a group of events including:
key presses on a keyboard, mouse movements, mouse button presses, mouseovers, touch screen tactile interacts, voice commands, cursor alias movement, color changes, menu selections, and any combination thereof.

5. The method of claim 1, where the cursor is selected from a group comprising a real cursor, a cursor alias, a mouse cursor, and any combination thereof.

6. The method of claim 1, where the pertinent user interface elements are selected from a group including text, graphics, audio, form elements, such as headers, labels, lists, and user input elements, such as a text fields, checkboxes, radio-buttons, data grids, links and buttons, and any combination thereof.

7. The method of claim 1, where the information displayed in the tooltip is selected from a group including graphical and textual elements, such as buttons, multimedia, lists, grids, text narratives, text labels, and blurbs, and any combination thereof.

8. The method of claim 1, where the tooltip is positioned within close proximity to at least one of the other user interface elements.

9. The method of claim 1, where the tooltip is abutting at least one of the other user interface elements.

10. The method of claim 1, where the tooltip is overlapping at least one of the other user interface elements.

11. The method of claim 1, where a tooltip controller facilitates controlling attributes of the tooltip, the attributes controlled including at least one of:
overall size of the tooltip and elements of the tooltip; specific elements of the tooltip to hide; specific elements of the tooltip to display; volume of audio output and muting audio output; colors of the tooltip; manual positioning of the tooltip; automated positioning of the tooltip; default positioning of the tooltip; speed of the tooltip positioning and appearing; speed of the tooltip hiding; flashing of the tooltip and elements of the tooltip; content of the tooltip and elements of the tooltip; and administrative rights of the tooltip.

12. The method of claim 1, where activation and deactivation of the tooltip is automatic, so that the tooltip appears and disappears based on an occurrence of a particular user event from another source selected from a group including operating system messages, application messages, hardware messages, network communications, embedded algorithm communications, and timer communications.

13. The method of claim 1, where deactivation of the tooltip results from a particular user event so that the tooltip appears indefinitely until an occurrence of the particular user event.

14. A method implemented by an event handler, comprising:
monitoring for at least one event at a first user interface element and at a second user interface element, where the first user interface element is an indicator of position having a location and where the second user interface element is at the location of the indicator of position;
activating a tooltip upon occurrence of the monitored event, where the tooltip when activated displays information associated with the second user interface element; and
controlling a size and a location of the tooltip with respect to the first and second user interface elements so at least the first and second user interface elements and the tooltip are within view of a user at various degrees of screen magnification.

15. The method of claim 14, where
the method occurs within an active application window and the first and second user interface elements and the tooltip are within view without having to scroll the application window; and
the active application window comprises the first user interface element, which is a cursor, and the event comprises the cursor entering the second user interface element.

16. The method of claim 14, where the event is selected from a group of events including:
key presses on a keyboard, mouse movements, mouse button presses, mouseovers, touch screen tactile interacts, voice commands, cursor alias movement, color changes, menu selections, and any combination thereof.

17. The method of claim 14, where:
the first user interface element is selected from a group of position indicators including a real cursor, a cursor alias, a mouse cursor, and any combination thereof; and
the second user interface element is selected from a group including text, graphics, audio, form elements, such as headers, labels, lists, and user input elements, such as a text fields, checkboxes, radio-buttons, data grids, links and buttons, and any combination thereof.

18. The method of claim 14, where the location of the tooltip is selected from a group including being within close proximity to the second user interface element, abutting the second user interface element, and overlapping the second user interface element.

19. A user interface display system including:
a processor; and
a memory that stores instructions for execution by said processor, said instructions implementing an event handler, said event handler comprising:
means for monitoring for at least one event occurring with respect to a cursor of a user interface;
means for activating a tooltip upon the monitored event occurring, where the tooltip when activated displays information pertinent to other user interface elements at the location of the cursor; and
means for controlling the size and the location of the tooltip with respect to the other user interface elements so that the information pertinent to the other user interface elements are within view of a user at various degrees of screen magnification.

20. A computer readable storage medium that stores computer-executable instructions that when executed by a processor cause the processor to implement a method comprising the steps of:
monitoring for at least one event occurring with respect to a cursor of a user interface;
activating a tooltip upon the monitored event occurring, where the tooltip when activated displays information pertinent to other user interface elements at the location of the cursor; and
controlling the size and the location of the tooltip with respect to the other user interface elements so that the information pertinent to the other user interface elements are within view of a user at various degrees of screen magnification.
